(19) United States
(12) Patent Application Publication
(10) Pub. No.: US 2014/0122137 A1
(43) Pub. Date: May 1, 2014

(54) IDENTIFIED CUSTOMER REPORTING

(71) Applicant: TARGET BRANDS, INC., Minneapolis, MN (US)

(72) Inventors: James Carl Nelson, Burnsville, MN (US); Abhijit Sharma, Bangaluru (IN); Zachary George Sands, St. Paul, MN (US)

(73) Assignee: TARGET BRANDS, INC., Minneapolis, MN (US)

(21) Appl. No.: 13/665,415

(22) Filed: Oct. 31, 2012

(51) Int. Cl. G06Q 10/04

(52) U.S. Cl. 705/7.11

(57) ABSTRACT

Customer data is retrieved that includes customer transactions of a retailer for a first time period and a second time period prior to the first time period. Each customer transaction may be associated with an identified customer. Customer transactions that occurred during the second time period and that are associated with an identified customer that was identified after the second time period are removed from the customer data. For each identified customer, a customer identification weighting factor is determined based on a customer identification likelihood. A total number of customer transactions associated with the identified customer is multiplied by the identification weighting factor to determine a weighted total number of customer transactions for the identified customer. The weighted total number of customer transactions for the identified customer is associated with the identified customer in the customer data. A report including a representation of the customer data is output.

### BACKGROUND

Retailers may generate various analytical reports. Such reports may help the retailer to quantify its past performance, measure its performance against various business goals, and better understand its connection to the marketplace. To this end, retailers may generate analytical reports including a variety of information, such as a year-over-year comparison of revenues or profits. In some examples, a retailer may wish to report a number of unique customers that have made purchases at the retailer. As customers become more familiar with a retailer, such customers may increase the number of purchases they make at the retailer over time. Accordingly, an increase in the number of unique customers that have made purchases at the retailer (e.g., a year-over-year increase in the number of such customers) may indicate a potential for increased future revenues for the retailer.

### SUMMARY

In general, this disclosure relates to techniques for adjusting customer transaction data associated with identified customers of a retailer. The techniques may enable more accurate comparisons of the identified customer transactions over time, such as for year-over-year reporting of identified customer transactions. In one example, a method includes retrieving, with a computing device, a first set of customer data including a first plurality of customer transactions of a retailer for a first time period and a second time period prior to the first time period. Each customer transaction of the first plurality of customer transactions may be associated with an identified customer of a plurality of identified customers. An identified customer may include a customer that is associated with a name of the identified customer and one or more of a mailing address of the identified customer and an email address of the identified customer. The method also includes removing, with the computing device, one or more customer transactions from the first set of customer data, each of which customer transaction occurred during the second time period and is associated with an identified customer that was identified after the first time period so as to determine a second set of customer data including a second plurality of customer transactions of the retailer for the first time period and the second time period. The method also includes, for each identified customer of the plurality of identified customers, determining, with the computing device, a customer identification weighting factor for the identified customer based on a customer identification likelihood, multiplying, with the computing device, a total number of customer transactions of the second plurality of customer transactions associated with the identified customer by the customer identification weighting factor to determine a weighted total number of customer transactions for the identified customer, and associating, with the computing device, the weighted total number of customer transactions for the identified customer with the identified customer in the second set of customer data. The method also includes outputting, with the computing device, a report including a representation of the second set of customer data.

In another example, a computing device includes at least one computer-readable storage device and at least one processor. The at least one computer-readable storage device is configured to store a first set of customer data comprising a first plurality of customer transactions of a retailer for a first time period and a second time period prior to the first time period, wherein each customer transaction of the first plurality of customer transactions is associated with an identified customer. The at least one processor is configured to access information stored on the at least one computer-readable storage device and to perform operations including removing one or more customer transactions from the first set of customer data stored on the at least one computer-readable storage device, each of which customer transaction occurred during the second time period and is associated with an identified customer that was identified after the second time period so as to determine a second set of customer data comprising a second plurality of customer transactions of the retailer for the first time period and the second time period. The at least one processor is also configured to, for each identified customer of the plurality of identified customers, determine a customer identification weighting factor for the identified customer based on a customer identification likelihood, multiply a total number of customer transactions of the second plurality of customer transactions associated with the identified customer by the customer identification weighting factor to determine a weighted total number of customer transactions for the identified customer, and associate the weighted total number of customer transactions for the identified customer with the identified customer in the second set of customer data. The at least one processor is also configured to output a report comprising a representation of the second set of customer data.

In another example, a computer-readable storage device encoded with instructions that, when executed, cause one or more processors of a computing device to remove one or more customer transactions from a first set of customer data. The first set of customer data comprises a first plurality of customer transactions of a retailer for a first time period and a second time period prior to the first time period. Each customer transaction of the first plurality of customer transactions is associated with an identified customer of a plurality of identified customers. Each of customer transaction removed from the first set of customer data occurred during the second time period and is associated with an identified customer that was identified after the second time period so as to determine a second set of customer data comprising a second plurality of customer transactions of the retailer for the first time period and the second time period. The instructions, when executed, also cause the one or more processors of the computing device to, for each identified customer of the plurality of identified customers, determine a customer identification weighting factor for the identified customer based on a customer identification likelihood, determine a weighted total number of customer transactions for the identified customer based on the customer identification weighting factor for the identified customer, associate the weighted total number of customer transactions for the identified customer with the identified customer in the second set of customer data. The instructions, when executed, also cause the one or more processors of the computing device to output a report comprising a representation of the second set of customer data.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system for generating a report including customer transaction data associated with identified customers of a retailer.

FIG. 2 is a block diagram illustrating an example computing device that may generate a report including customer transaction data associated with identified customers of a retailer.

FIG. 3 is a flow diagram illustrating example operations of a computing device to generate a report including customer transaction data associated with identified customers of a retailer.

FIGS. 4A and 4B are flow diagrams illustrating the example operations of FIG. 3 to determine a customer identification weighting factor in further detail.

FIGS. 5A-5C are example illustrations of reports including customer transaction data associated with identified customers of a retailer.

### DETAILED DESCRIPTION

In general, techniques of this disclosure are directed to adjusting customer transaction data associated with identified customers of a retailer to enable more accurate and meaningful comparisons of the identified customer transactions over time. The retailer may include one or more retail stores. For example, the retailer may be a single retail store that offers products for sale to customers. As another example, the retailer may be a business entity that controls or otherwise operates multiple retail store locations. Customers may purchase items at one or more retail stores of the retailer. Customers may become more familiar with the retailer and products offered for sale by the retailer as they shop at the retailer over time. As customers become more familiar with the retailer, they may purchase more items from the retailer.

Accordingly, the retailer may wish to determine the number of unique customers that have made purchases at the retailer over a period of time. For instance, increases in the number of unique customers that have made purchases at the retailer may indicate a potential for increased revenues at the retailer as those customers continue to purchase items at the retailer in the future. Similarly, decreases in the number of such unique customers may indicate less potential for increased revenues, or even possible decreases in future revenues.

To determine the number of unique customers that have made transactions at the retailer, the retailer may identify customers using information gathered during point of sale (POS) transactions at the retailer. For example, customers may purchase items at the retailer using various types of tender, such as cash, check, credit cards, and the like. Certain types of tender may enable the retailer to associate a unique payment account number (e.g., a debit card account number, a credit card account number, etc.) and a name of the customer with the POS transaction. Such tender types, including credit cards, debit cards, gift cards, and the like, may be considered identifiable tender versus other types of tender like cash which may not be identified as associated with a particular customer of the retailer.

However, because any given customer may use multiple such payment accounts to purchase items at the retailer (e.g., multiple credit cards) and multiple customers may have the same name, information related to a payment account alone may be insufficient to enable the retailer to determine the number of unique customers that have made purchases at the retailer. For instance, a customer named John Doe may have three different credit card accounts. John Doe may use any one of the credit card accounts during a particular transaction to purchase items at the retailer. Similarly, a different customer, also named John Doe may make purchases at the retailer using one or more different credit card accounts. In such an example, the retailer may be unable to discern whether transactions at the retailer are associated with one customer named John Doe or multiple customers named John Doe. Similarly, for any particular transaction with a payment account associated with a customer named John Doe, the retailer may be unable to discern which customer named John Doe made the purchase.

As such, to uniquely identify a customer associated with a transaction at the retailer using an identifiable tender (e.g., credit card, debit card, gift card, etc.), the retailer may associate the name of the customer with an address of the customer. The address may be a physical mailing address of the customer, an email address of the customer, or both. The retailer may consider a customer that has been associated with both a name of the customer and an address of the customer to be an identified customer. However, such address information may not typically be readily available to the retailer from the POS transaction. That is, when a customer purchases an item at the retailer using an identifiable tender, the retailer may be provided with information associated with a name of the customer and a payment account number of the tender, but not with an address of the customer.

Accordingly, to uniquely identify the customer associated with the transaction, the retailer may attempt to associate the name of the customer involved with the transaction with an address of the customer using a database or other data repository that includes information relating to both an address and a name of potential customers. For instance, some vendors provide a service to enable retailers to make such associations. In some examples, a retailer may determine that a customer transaction is associated with an unidentified customer (i.e., a customer that is not associated with both a name and an address of the customer), and may send the name information to the vendor. The vendor may attempt to associate the name of the customer with an address of the customer (e.g., a physical mailing address) using a database including name information and physical address information. For instance, the vendor may determine that a name of a customer is associated with a particular address, such as by determining a number of names and associated mailing addresses that are physically located within a predetermined distance from the retail store at which the transaction occurred. In some examples, after the vendor associates the name and address information within a predetermined confidence level, the vendor may send the associated name and address information to the retailer. The retailer may use the associated name and address information to uniquely identify the customer.

However, the association of the name and address information to uniquely identify the customer may take time. For instance, the vendor may be initially unable to associate the name and address information, such as when the vendor lacks sufficient information in its database to make the association within the predetermined confidence level. In such cases, the vendor may make various attempts to associate the name and address information over a period of time. As one example, it may take between three weeks and eighteen months to associate the name and address information so as to uniquely identify the customer.

The time lag between the unidentified customer transaction and the identification of the customer may affect reports generated by the retailer regarding customer transactions associated with identified customers over a period of time. As one example, the retailer may generate a report to indicate the number of customer transactions associated with identified customers for a particular reporting period, such as of the months of January to December of the year 2011. However, in such an example, unidentified customer transactions from earlier portions of the reporting period (e.g., the first quarter of 2011) have had more time to become identified customer transactions. That is, because the report relates to past transactions, customer transactions from earlier portions of the reporting period that were associated with unidentified customers at the time of the transaction have more time to enable the retailer (or vendor) to associate name information with address information of the unidentified customer so as to uniquely identify the customer. Accordingly, a trend of the number of identified customer transactions indicated by the report over a particular reporting period may tend to decrease over the reporting period, or increase at a lesser rate than it would otherwise increase absent the time lag introduced by the customer identification process.

In a similar example, the retailer may generate a report to compare the number of customer transactions associated with identified customers for one reporting period to customer transactions associated with identified customers for a previous reporting period (e.g., a year-over-year comparison of customer transactions associated with identified customers). In such an example, the time lag relating to the identification process (i.e., a time between a customer transaction associated with an unidentified customer and a time when the transaction is associated with both a name and an address of the customer so as to identify the customer) may affect the information included in the report.

For example, at the end of the year 2011, the retailer may generate a report to compare the number of monthly customer transactions associated with identified customers for the year 2011 with the number of monthly customer transactions associated with identified customer for the year 2010 to determine a percentage of increase or decrease of such customer transactions for each month of the reporting years. However, in such an example, at the end of the year 2011 when the report is generated, customer transactions in the year 2010 that were, at the time of the transaction, associated with unidentified customers have had more time to be associated with both a name and an address of the customer so as to be considered identified customer transactions. Similarly, in this example, at the end of the year 2011 when the report is generated, customer transactions at the end of the year 2010 that were, at the time of the transaction, associated with unidentified customers have had a year or more to be associated with both a name and an address of the customer so as to be considered identified customer transactions, whereas customer transactions associated with unidentified customers at the end of the year 2011 have had less than a month to be associated with a name and an address of the customer. As such, the report may indicate a decreasing trend in the percentage of customer transactions associated with identified customers as between the reporting periods when, in fact, the trend of such identified customer transactions would be an increasing trend absent the time lag associated with the customer identification process.

Techniques described herein may enable a retailer to adjust customer transaction data associated with identified customers of the retailer to compensate for the time lag introduced into the customer transaction data by the customer identification process, thereby enabling more accurate comparisons of the identified customer transactions between reporting periods. According to various techniques of this disclosure, a computing device may retrieve customer data including customer transactions associated with identified customers of a retailer for a first reporting period (e.g., the year 2011) and a second, prior reporting period (e.g., the year 2010). The computing device may remove from the customer transaction data, one or more of the customer transactions of the second reporting period (e.g., the year 2010), each of which is associated with an identified customer that was identified after the second reporting period (e.g., after the year 2010). As such, the computing device may enable a more accurate comparison, as between the reporting periods, of customer transactions associated with identified customers.

For instance, because customer transactions of the first reporting period (e.g., the year 2011) have had less time (or, in certain examples, no time) to be associated with both a name and an address of the customer so as to be considered identified customer transactions, a comparison of those customer transactions of the first reporting period (e.g., year 2011) with customer transactions of the second reporting period (e.g., the year 2010) associated with customers that were identified (i.e., associated with both a name and an address of the customer) after the second reporting period (e.g., the year 2010) may affect the trend of customer transactions associated with identified customers due to the time lag introduced by the customer identification process. By removing such customer transaction data, the computing device may enable a comparison of customer transactions associated with identified customers between reporting periods that is less affected by the time lag of the customer identification process.

In some examples, techniques described herein may enable a retailer to adjust customer transaction data associated with identified customers of the retailer for each time period of the reporting period. For example, a computing device may retrieve customer data including customer transactions associated with identified customers of a retailer for a first reporting period (e.g., the year 2008) and a second, prior reporting period (e.g., the year 2007). In such an example, the computing device may remove from the customer transaction data, one or more of the customer transactions of the second reporting period (e.g., the year 2007), each of which is associated with an identified customer that was identified after the second reporting period (e.g., after the year 2007). In addition, the computing device may remove from the customer transaction data, one or more of the customer transactions of the first reporting period (e.g., the year 2008), each of which is associated with an identified customer that was identified after the first reporting period (e.g., after the year 2008). As such, the computing device may remove from the customer transaction data those customer transactions associated with an identified customer that was identified after the reporting period within which the customer transaction occurred, thereby enabling a more accurate comparison, as between the reporting periods, of customer transactions associated with identified customers.

In addition, techniques described herein may enable the retailer to further adjust the customer transaction data associated with identified customers of the retailer to compensate for biases introduced by a likelihood of successfully identifying a payment account associated with a customer transaction sometime in the future. For instance, an identification success rate (e.g., a percentage of payment accounts that are successfully identified with a customer) may be dependent upon one or more characteristics of the payment account. Such characteristics may include, for example, an age of the payment account, a type of the payment account, and a region of the payment account.

As an example the retailer may successfully identify a higher percentage of customers using payment accounts associated with the retailer (e.g., credit cards, debit cards, gift cards, etc. issued by or otherwise affiliated with the retailer) than customers using payment accounts associated with third-party financial institutions (e.g., third-party credit cards, debit cards, etc.) Similarly, the retailer may successfully identify a higher percentage of customers using payment accounts associated with certain third-party financial institutions than with other third-party financial institutions. As another example, the retailer may successfully identify a higher percentage of customers associated with transactions made in certain geographic regions than others. For instance, the retailer may successfully identify a higher percentage of customers associated with transactions made in Minnesota than in Louisiana, or a higher percentage of customers associated with transactions made in the Midwest than in the New England states. Such geographic biases may be due, in part, to a number of retail stores of the retailer that are physically located in the geographic region. The likelihood of identification of a customer associated with a payment account may introduce biases into the customer transaction data. For instance, customers associated with payment accounts that are less likely to enable a successful identification of the customer may be underrepresented in the customer data.

According to various techniques of this disclosure, the computing device may apply one or more weighting factors to customer transactions associated with identified customers to compensate for such biases introduced into the customer transaction data by the customer identification process. For example, the computing device may determine a weighting factor for a payment account associated with an identified customer based on a percentage of other payment accounts including the characteristics of the payment account that have been successfully identified by the retailer. The computing device may assign a higher payment account weighting factor to those payment accounts that have been less successfully identified by the retailer, thereby increasing the representation of transactions associated with those payment accounts in the customer transaction data. In certain examples, the computing device may assign an identified customer weighting factor to an identified customer based on a weighted average of the payment account weighting factors associated with the identified customer. In such examples, the computing device may adjust the total number of customer transactions associated with the identified customer based on the identified customer weighting factor, thereby compensating for biases introduced in the customer transaction data relating to the likelihood of identifying the customer using the customer identification process.

As such, techniques described herein may enable a retailer to adjust customer transaction data associated with identified customers of the retailer to compensate for biases introduced into the customer transaction data by the customer identification process. The techniques may enable more accurate comparisons of the identified customer transactions, thereby enabling more meaningful reports of such information.

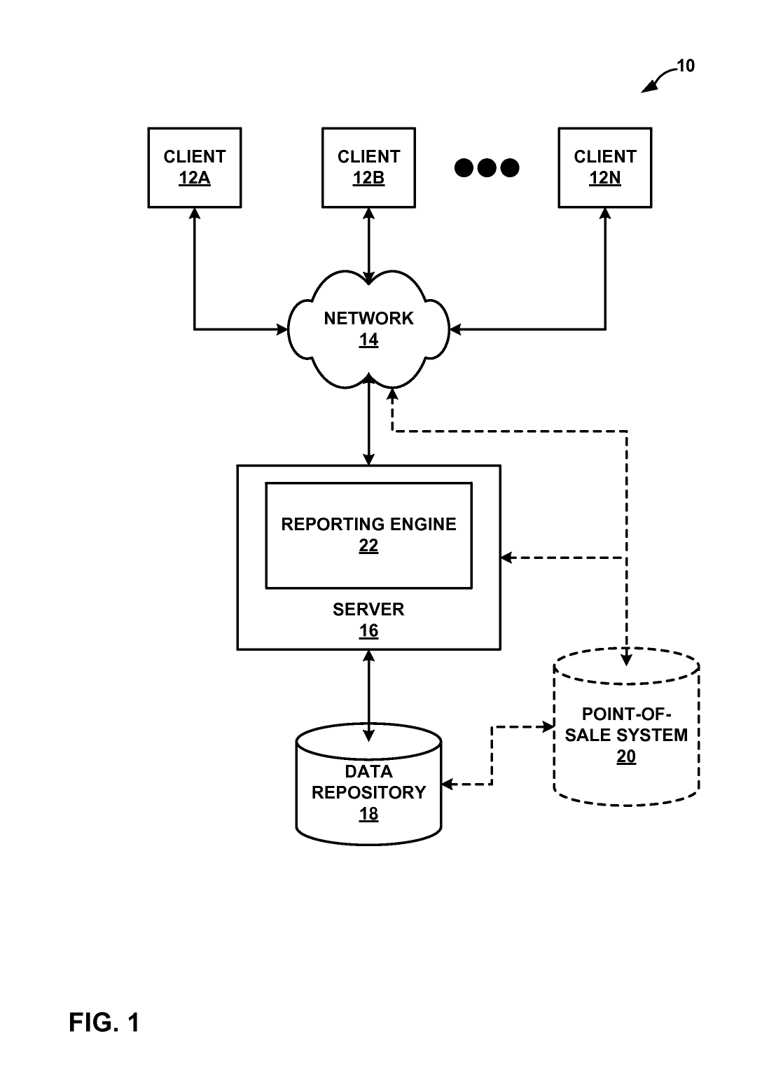

FIG. 1 is a conceptual diagram illustrating an example system 10 for generating a report including customer transaction data associated with identified customers of a retailer. As illustrated in the example of FIG. 1, system 10 may include clients 12A-12N (collectively referred to herein as “clients 12”), network 14, server 16, data repository 18, and point-of-sale (POS) system 20. In addition, server 16 may include reporting engine 22.

Clients 12, server 16, data repository 18, and point-of-sale system 20 may be communicatively coupled via network 14. Network 14 may include one or more terrestrial and/or satellite networks interconnected to provide a means of communicatively connecting clients 12 to server 16, POS system 20, and data repository 18. For example, network 14 may be a private or public local area network (LAN) or Wide Area Network (WANs). Network 140 may include both wired and wireless communications according to one or more standards and/or via one or more transport mediums. For example, network 14 may include wireless communications according to one of the 802.11 or Bluetooth specification sets, or another standard or proprietary wireless communication protocol. Network 14 may also include communications over a terrestrial cellular network, including, e.g. a GSM (Global System for Mobile Communications), CDMA (Code Division Multiple Access), EDGE (Enhanced Data for Global Evolution) network. Data transmitted over network 14, e.g., from clients 12 to server 16 may be formatted in accordance with a variety of different communications protocols. For example, all or a portion of network 14 may be a packet-based, Internet Protocol (IP) network that communicates data from clients 12 to data server 16 in Transmission Control Protocol/Internet Protocol (TCP/IP) packets, over, e.g., Category 5, Ethernet cables.

Examples of clients 12 may include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others. Server 16 may be any of various types of network devices. For example, server 16 may include a data processing appliance, web server, specialized media server, personal computer operating in a peer-to-peer fashion, or another type of network device. Additionally, although example system 10 of FIG. 1 includes a single server 16, other examples may include two or more collocated or distributed servers configured for generating a report including customer transactions associated with identified customers of a retailer.

Data repository 18 and/or POS system 20 may each include, e.g., a standard or proprietary electronic database or other data storage and retrieval mechanism. For instance data repository 18 and/or POS system 20 may each include one or more databases, such as relational databases, multi-dimensional databases, hierarchical databases, object-oriented databases, or one or more other types of databases. Data repository 18 and/or POS system 20 may be implemented in software, hardware, and combinations of both. For example, data repository 18 and/or POS system 20 may include proprietary database software stored on one of a variety of storage mediums on a data storage server connected to network 14 and configured to store information associated with customer transactions and identified customers of a retailer. Storage media included in or employed in cooperation with data repository 18 and/or POS system 20 may include, e.g., any volatile, non-volatile, magnetic, optical, or electrical media, such as a random access memory (RAM), read-only memory (ROM), non-volatile RAM (NVRAM), electrically-erasable programmable ROM (EEPROM), flash memory, or any other digital media.

Data repository 18 and/or POS system 20 may store information associated with customer transactions of a retailer. Examples of such information may include past customer transactions at one or more retail stores of the retailer, payment account information associated with such transactions, and information associated with one or more identified and unidentified customers associated with transactions at the retailer. In one example, POS system 20 receives and processes data associated with customer transactions of the retailer at various locations of the retailer. Server 16 may periodically retrieve raw POS customer transaction data from POS system 20 and may store the data or process and then store the data in data repository 18.

Although data repository 18, POS system 20, and server 16 are illustrated as separate components in example system 10 of FIG. 1, in other examples two or more of these components may be combined or may each be distributed among more than one device. For example, server 16 may include data repository 18 and/or POS system 20 and control the corresponding data to generate a report including customer transactions associated with identified customers of the retailer. In another example, data repository 18 may be distributed among a number of separate devices, e.g. a number of database servers, and server 16 may include a number of co-located or distributed servers configured to operate individually and/or in cooperation with one another and with the various devices comprising data repository 18.

As illustrated in FIG. 1, server 16 may include reporting engine 22, which may be configured or otherwise operable to retrieve customer data and generate a report including customer transaction data associated with identified customers of a retailer. Clients 12 may be client computers from which users access and interact with reporting engine 22. For example, clients 12 may run a web browser that accesses and presents a web application executed by server 16 or another device and allows a user to generate a report including customer transaction data associated with identified customers of a retailer in accordance with the examples of this disclosure. In another example, clients 12 may execute an application outside of a web browser, e.g. an operating system specific application like a Windows application or Apple OS application that accesses and presents a web application executed by server 16 or another device and allows a user to generate a report including customer transaction data associated with identified customers of a retailer in accordance with the examples of this disclosure. In another example, one or more of clients 12 may store and execute reporting engine 22 locally.

Reporting engine 22 may use data obtained from one or more of data repository 18 and POS system 20 to adjust customer transaction data including customer transactions associated with identified customers of a retailer to enable more accurate comparisons of the customer transaction data between reporting periods. For example, reporting engine 22 may retrieve a first set of customer data from data repository 18. The first set of customer data may include a first plurality of customer transactions of the retailer for a first time period and a second time period prior to the first time period. For instance, the first plurality of customer transactions may include customer transactions for a first time period of the year 2011 and a second time period of the year 2010. Some or all of the customer transactions included in the first set of customer data retrieved from data repository 18 by reporting engine 22 may be associated with an identified customer of the retailer. An identified customer may be a customer that is associated with a name of the identified customer and one or more of a mailing address of the identified customer and an email address of the identified customer.

According to various techniques of this disclosure, reporting engine 22 may adjust the customer data including customer transactions associated with identified customers of the retailer to compensate for biases introduced into the customer data by the customer identification process. For instance, reporting engine 22 may adjust the customer data to compensate for a time lag bias introduced into the customer data based on the time between a customer transaction at the retailer and a time when the customer transaction is associated with a name and address of a customer so as to associate the customer transaction with an “identified” customer.

As one example, reporting engine 22 may remove one or more customer transactions from the first set of customer data, each of which occurred during the second time period and is associated with an identified customer that was identified after the second time period so as to determine a second set of customer data comprising a second plurality of customer transactions of the retailer for the first time period and the second time period. For instance, reporting engine 22 may remove one or more customer transactions from the first set of customer data retrieved from data repository 18 that occurred during the second time period and are associated with an identified customer that was identified after the year 2010 (i.e., the second time period in this example). As such, reporting engine 22 may determine a second set of customer data that does not include customer transactions that occurred during the year 2010 and are associated with identified customers that were identified after the year 2010, thereby enabling a more accurate comparison of customer transactions associated with identified customers of the retailer as between the reporting years 2011 and 2010. That is, because unidentified customers associated with transactions from the reporting period of 2010 have had more time to be associated with both a name and an address of the customer so as to be considered identified customers than have customers associated with transactions from the reporting period of 2011, reporting engine 22 may remove customer transactions from the reporting period of 2010 that occurred during the reporting year 2010 and are associated with identified customers that were identified after the reporting year 2010, thereby enabling a more accurate comparison of such transactions with transactions from the reporting period of 2011 that have had less time to be associated with an identified customer of the retailer.

In certain examples, reporting engine 22 may remove one or more customer transactions from the first set of customer data, each of which occurred during the first time period and is associated with an identified customer that was identified after the first time period so as to determine a second set of customer data comprising a second plurality of customer transactions of the retailer for the first time period and the second time period. For instance, as in the above example, reporting engine 22 may remove one or more customer transactions from the first set of customer data retrieved from data repository 18 that occurred during the first time period and are associated with an identified customer that was identified after the year 2011 (i.e., the first time period in this example). As such, reporting engine 22 may determine a second set of customer data that does not include customer transactions that occurred during the year 2010 and are associated with identified customers that were identified after the year 2010, and does not include customer transactions that occurred during the year 2011 and are associated with identified customers that were identified after the year 2011.

In some examples, reporting engine 22 may further adjust the second set of customer transaction data (e.g., the set of customer transaction data from which one or more customer transactions from the second reporting year, the first reporting year, or both, have been removed) to better represent customer and transaction trends over time, such as by determining a weighted total number of customer transactions for each identified customer. As an example, reporting engine 22 may determine, for each identified customer of the second set of customer data, a customer identification weighting factor for the identified customer based on a customer identification likelihood. For instance, due in part to the customer identification process, a success rate of identifying a particular customer may be dependent upon one or more characteristics of one or more payment accounts associated with the customer. Such characteristics may include one or more of an age of the payment account (e.g., a length of time that the payment account has been used for customer transactions at the retailer), a type of the payment account (e.g., a type of credit card, such as a credit card associated with the retailer or a credit card associated with a third-party financial institution), or a region of the payment account (e.g., a geographic region at which the payment account is most often used for customer transactions at the retailer).

Reporting engine 22 may, in certain examples, retrieve customer data from data repository 18 including information associated with payment accounts associated with both identified and unidentified customers that include the characteristics of a payment account associated with an identified customer for which reporting engine 22 is determining a weighted total number of customer transactions. Reporting engine 22 may determine an identification success rate of the payment account as a percentage of payment accounts including the characteristics that have been successfully associated with both a name and address of a customer so as to be considered identified payment accounts. Reporting engine 22 may determine the customer identification likelihood based at least in part on the success rate of each payment account associated with the identified customer (e.g., a weighted average of the success rates of payment accounts associated with the identified customer).

Reporting engine 22 may determine, for each identified customer in the second set of customer data (i.e., the set of customer data from which one or more customer transactions have been removed), a weighted total number of customer transactions for the identified customer, such as by multiplying a total number of customer transactions associated with the identified customer by the customer identification weighting factor. As such, reporting engine 22 may adjust the second set of customer data to correct for biases introduced into the customer data by the customer identification process, thereby enabling even more accurate comparisons of customer transactions associated with identified customers of the retailer as between the first and second reporting periods.

Reporting engine 22 may generate a report including representation of the second set of customer data. For example, reporting engine 22 may generate a report including a comparison of customer transactions associated with identified customers of the retailer as between the first and second reporting periods of the adjusted second set of customer data. For instance, in such an example, the report may include a year-over-year percentage change of identified customer transactions between a first reporting year (e.g., the year 2011) and a second, prior reporting year (e.g., the year 2010). As such, techniques described herein may enable a retailer to generate a report including customer transactions associated with identified customers of the retailer. By compensating for biases introduced into the customer transaction data by the customer identification process, the techniques may enable a more accurate comparison of such customer transactions as between two or more reporting periods. As such, the techniques may enable the retailer to more accurately quantify its past business performance and generate future business goals.

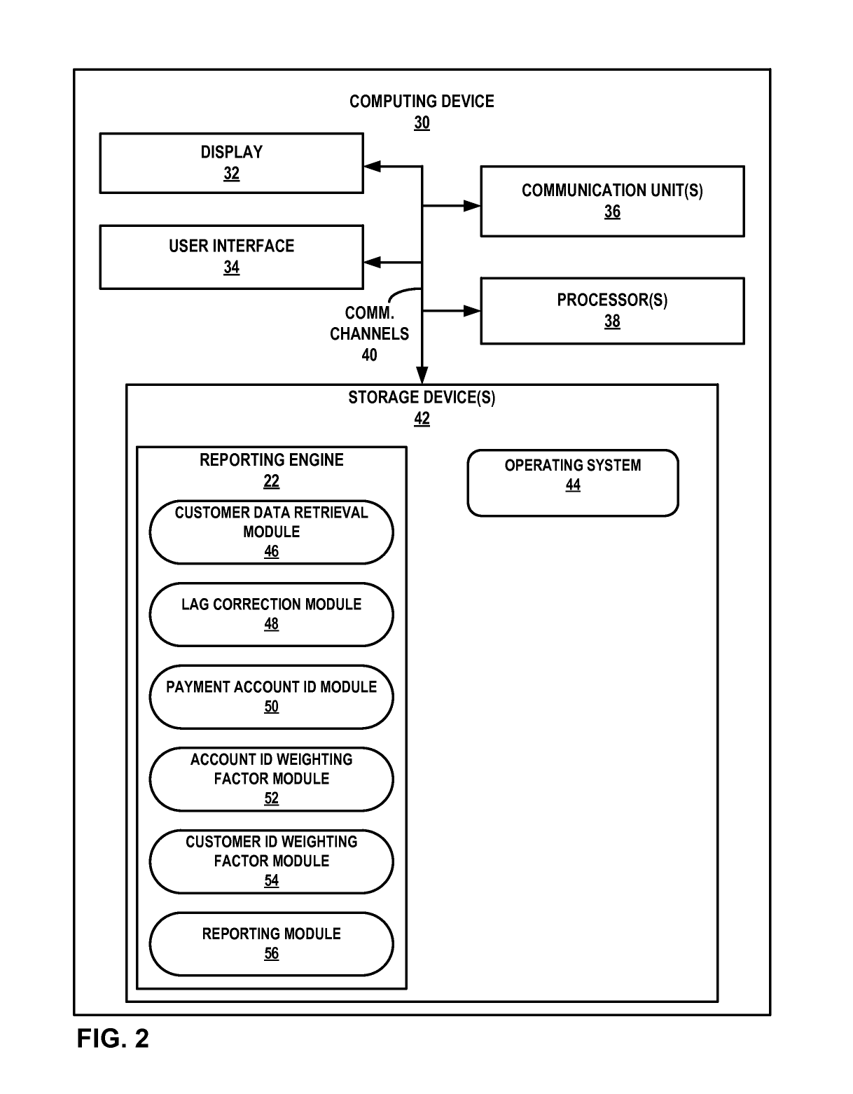

FIG. 2 is a block diagram illustrating an example computing device 30 that may generate a report including customer transaction data associated with identified customers of a retailer. FIG. 2 illustrates only one particular example of computing device 30, and many other examples of computing device 30 may be used in other instances. In addition, although discussed with respect to one computing device 30, one or more components and functions of computing device 30 may be distributed among multiple computing devices 30.

Computing device 30 may, in certain examples, be substantially similar to server device 16 of FIG. 1. As such, examples of computing device 30 may include, but are not limited to, various types of network devices such as a data processing appliance, web server, specialized media server, personal computer operating in a peer-to-peer fashion, or another type of network device. Additional examples of computing device 30 may include, but are not limited to, computing devices such as desktop computers, workstations, network terminals, and portable or mobile devices such as personal digital assistants (PDAs), mobile phones (including smart phones), tablet computers, laptop computers, netbooks, ultrabooks, and others.

As shown in the example of FIG. 2, computing device 30 includes display 32, user interface 34, one or more communication units 36, one or more processors 38, and one or more storage devices 42. As illustrated, computing device 30 further includes reporting engine 22 and operating system 44. Reporting engine 22 includes customer data retrieval module 46, lag correction module 48, payment account identification module 50, account identification weighting factor module 52, customer identification weighting factor module 54, and reporting module 56. Each of components 32, 34, 36, 38, and 42 may be interconnected (physically, communicatively, and/or operatively) for inter-component communications. In some examples, communication channels 40 may include a system bus, network connection, inter-process communication data structure, or any other channel for communicating data. As one example in FIG. 2, components 32, 34, 36, 38, and 42 may be coupled by one or more communication channels 40. Reporting engine 22, retrieval module 46, lag correction module 48, payment account identification module 50, account identification weighting factor module 52, customer identification weighting factor module 54, reporting module 56, and operating system 44 may also communicate information with one another as well as with other components of computing device 30.

Display 32 may be a liquid crystal display (LCD), e-ink, organic light emitting diode (OLED), or other display. Display 32 may present the content of computing device 30 to a user. For example, display 32 may display the output of reporting engine 22 executed on one or more processors 38 of computing device 30, confirmation messages, indications, or other functions that may need to be presented to a user. In some examples, display 32 may provide some or all of the functionality of a user interface of computing device 30. For instance, display 32 may be a touch-sensitive and/or presence-sensitive display that can display a graphical user interface (GUI) and detect input from a user in the form of user input gestures using capacitive or inductive detection at or near the presence-sensitive display.

User interface 34 may allow a user of computing device 30 to interact with computing device 30. Examples of user interface 34 may include, but are not limited to, a keypad embedded on computing device 30, a keyboard, a mouse, a roller ball, buttons, or other devices that allow a user to interact with computing device 30. In some examples, computing device 30 may not include user interface 34, and the user may interact with computing device 30 with display 32 (e.g., by providing various user gestures). In some examples, the user may interact with computing device 30 with user interface 34 and display 32.

Computing device 30, in some examples, also includes one or more communication units 36. Computing device 30, in one example, utilizes one or more communication units 36 to communicate with external devices (e.g., clients 12 of FIG. 1) via one or more networks, such as one or more wireless networks, one or more cellular networks, or other types of networks. One or more communication units 36 may be a network interface card, such as an Ethernet card, an optical transceiver, a radio frequency transceiver, or any other type of device that can send and receive information. Other examples of such network interfaces may include Bluetooth, 3G and WiFi radio computing devices as well as Universal Serial Bus (USB).

One or more processors 38, in one example, are configured to implement functionality and/or process instructions for execution within computing device 30. For example, one or more processors 38 may be capable of processing instructions stored at one or more storage devices 42, which may include, in some examples, instructions for executing functions attributed to reporting engine 22 and the modules thereof. Examples of one or more processors 38 may include any one or more of a microprocessor, a controller, a digital signal processor (DSP), an application specific integrated circuit (ASIC), a field-programmable gate array (FPGA), or equivalent discrete or integrated logic circuitry.

One or more storage devices 42 may be configured to store information within computing device 30 during operation. One or more storage devices 42, in some examples, may be described as a computer-readable storage medium. In some examples, one or more storage devices 42 may be a temporary memory, meaning that a primary purpose of one or more storage devices 42 is not long-term storage. One or more storage devices 42 may, in some examples, be described as a volatile memory, meaning that one or more storage devices 42 do not maintain stored contents when the computer is turned off. Examples of volatile memories include random access memories (RAM), dynamic random access memories (DRAM), static random access memories (SRAM), and other forms of volatile memories known in the art. In some examples, one or more storage devices 42 may be used to store program instructions for execution by one or more processors 38. One or more storage devices 42, for example, may be used by software or applications running on computing device 30 (e.g., reporting engine 22) to temporarily store information during program execution.

One or more storage devices 42, in some examples, also include one or more computer-readable storage media. One or more storage devices 42 may be configured to store larger amounts of information than volatile memory. One or more storage devices 42 may further be configured for long-term storage of information. In some examples, one or more storage devices 42 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

As illustrated in FIG. 2, computing device 30 may include reporting engine 22. Reporting engine 22 may include retrieval module 46, lag correction module 48, payment account identification module 50, account identification weighting factor module 52, customer identification weighting factor module 54, and reporting module 56. Although shown as separate components in FIG. 2, in some examples, one or more of reporting engine 22, retrieval module 46, lag correction module 48, payment account identification module 50, account identification weighting factor module 52, customer identification weighting factor module 54, and reporting module 56 may be part of the same module. In some examples, one or more of reporting engine 22, retrieval module 46, lag correction module 48, payment account identification module 50, account identification weighting factor module 52, customer identification weighting factor module 54, reporting module 56, and one or more processors 38 may be formed in a common hardware unit. In some instances, one or more of reporting engine 22, retrieval module 46, lag correction module 48, payment account identification module 50, account identification weighting factor module 52, customer identification weighting factor module 54, and reporting module 56 may be software and/or firmware units that are executed on one or more processors 38. In general, the modules of reporting engine 22 are presented separately for ease of description and illustration. However, such illustration and description should not be construed to imply that these modules of reporting engine 22 are necessarily separately implemented, but can be in some examples.

Computing device 30 may include operating system 44. Operating system 44, in some examples, controls the operation of components of computing device 30. For example, operating system 44, in one example, facilitates the communication of reporting engine 22 with one or more processors 38, display 32, user interface 34, and one or more communication units 36.

Computing device 30 may include additional components not shown in FIG. 2. For example, computing device 30 may include a battery to provide power to the components of computing device 30. Similarly, the components of computing device 30 may not be necessary in every example of computing device 30. For instance, in certain examples computing device 30 may not include display 32.

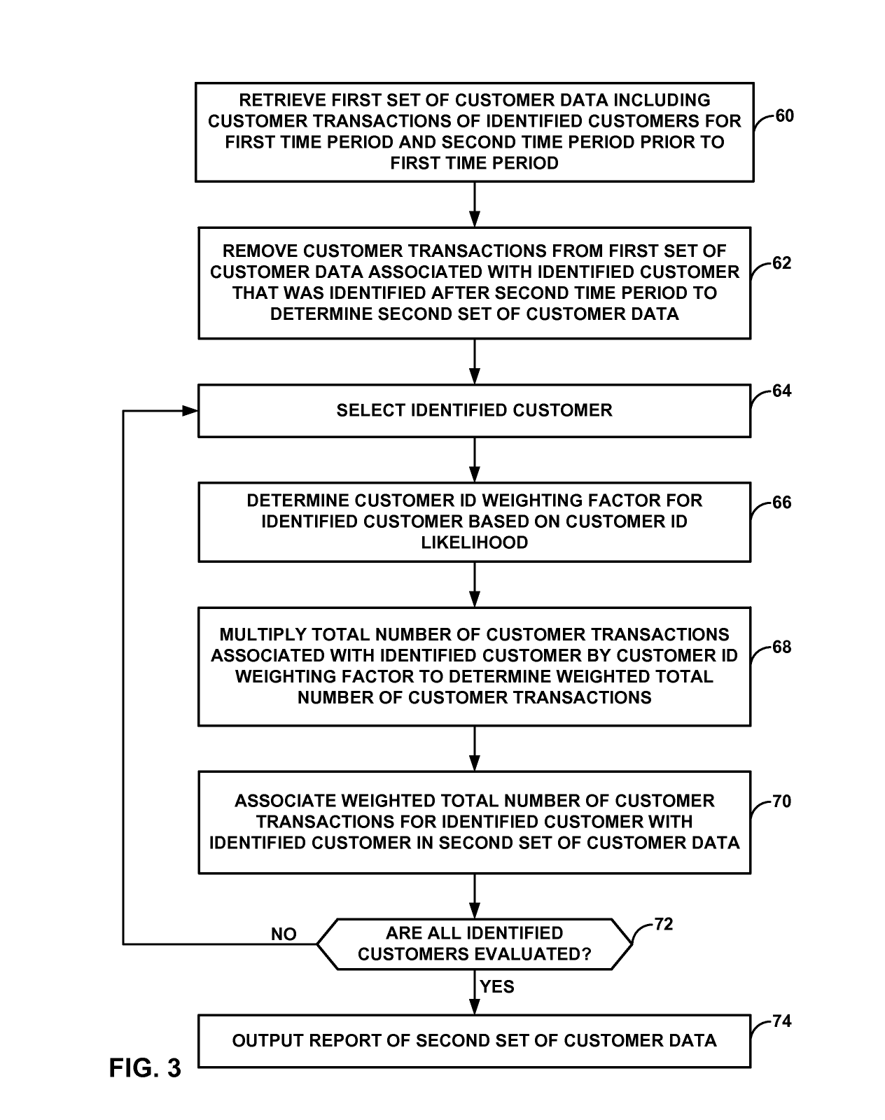

FIG. 3 is a flow diagram illustrating example operations of a computing device to generate a report including customer transaction data associated with identified customers of a retailer. The example illustrated in FIG. 3 is only one example operation, and other implementations may include more or fewer aspects than those depicted in FIG. 3. For purposes of illustrations only, the example operations are described below as carried out by computing device 30.

Customer data retrieval module 46, executing on one or more processors 38, may retrieve a first set of customer data including a first plurality of customer transactions of a retailer for a first time period and a second time period prior to the first time period (60). Each customer transaction of the first plurality of customer transactions may be associated with an identified customer of a plurality of identified customers. An identified customer may include a customer that is associated with a name of the identified customer and one or more of a mailing address of the identified customer and an email address of the identified customer.

As an example, customer data retrieval module 46 may retrieve a set of customer data including a plurality of customer transactions for a first reporting time period of the year 2011 and a second reporting time period of the year 2010. Each of the customer transactions may be associated with an identified customer, such that each of the customer transactions is associated with a name of a customer and an address of the customer. The address of the customer may include one or more of a mailing address of the customer and an email address of the customer. In some examples the identified customer information retrieved by computing device 30 or accessible to a user of computing device 30 may not include a name and/or address of the customer, but instead may include a different unique identifier of the customer, such as a unique identification number assigned to the customer, to enable computing device 30 to uniquely identify a customer while maintaining the privacy of the customer information.

Lag correction module 48, executing on one or more processors 38, may remove one or more customer transactions from the first set of customer data, each of which occurred during the second time period and is associated with an identified customer that was identified after the second time period so as to determine a second set of customer data comprising a second plurality of customer transactions of the retailer for the first time period and the second time period (62). For example, lag correction module 48 may determine one or more customer transactions of the retrieved set of customer data that occurred during the year 2010 (i.e., the second time period in this example) and are associated with an identified customer that was identified after the year 2010. In some examples, lag correction module 48 may remove one or more customer transactions from the first set of customer data, each of which occurred during the first time period and is associated with an identified customer that was identified after the first time period so as to determine the second set of customer data. For instance, lag correction module 48 may determine one or more customer transactions of the retrieved set of customer data that occurred during the year 2011 (i.e., the first time period in this example) and are associated with an identified customer that was identified after the year 2011. In certain examples, lag correction module 48 may remove one or more customer transactions from the first set of customer data each of which occurred during the first time period and is associated with an identified customer that was identified after the first time period, and may remove one or more customer transactions from the first set of customer data each of which occurred during the second time period and is associated with an identified customer that was identified after the second time period. As such, lag correction module 48 may help to compensate for a time lag bias introduced into the retrieved customer data by the customer identification process.

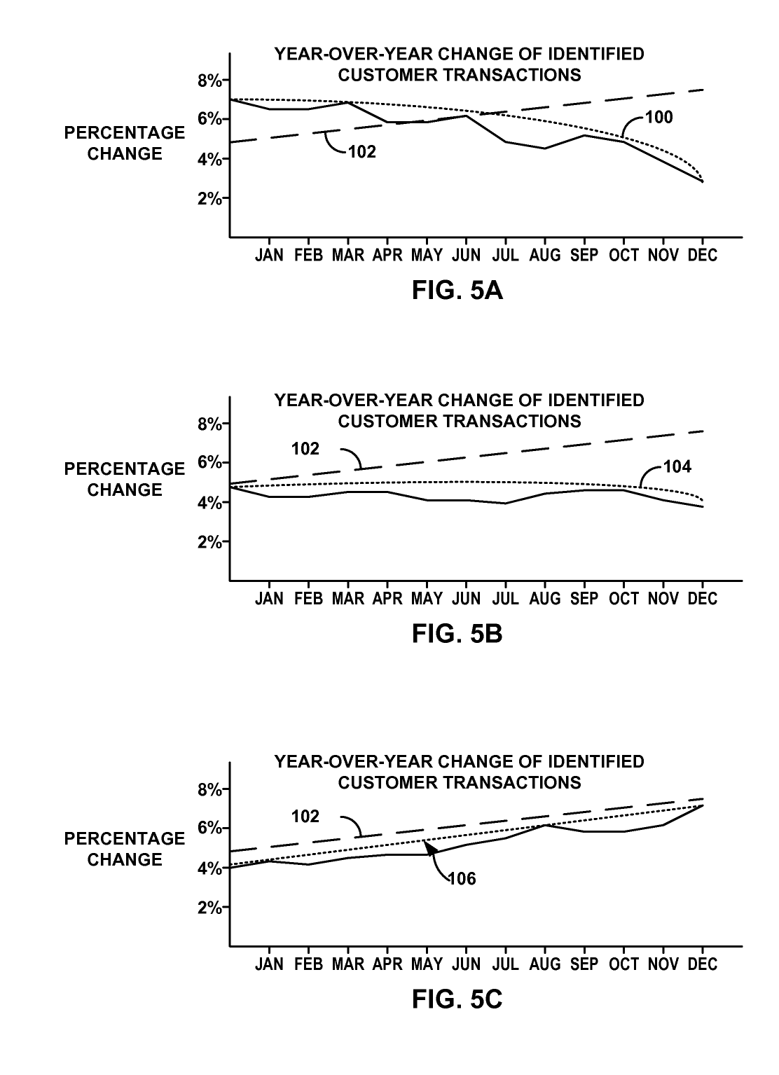

The compensation for the time lag bias may enable a more accurate comparison of customer transactions associated with identified customers of the retailer as between the first time period (e.g., the year 2011) and the second time period (e.g., the year 2010). For instance, compensation for the time lag bias may provide a more accurate indication of a trend of the change in customer transactions associated with identified customers over the reporting periods. For instance, FIGS. 5A-5C are example illustrations of reports of a year-over-year change of customer transactions associated with identified customers of a retailer. However, it should be understood that FIGS. 5A-5C are example illustrations only, and are not based on any experimental results or actual customer data, but are provided for purposes of illustration only.

In particular, FIG. 5A illustrates an example of a report that may be generated based on customer data prior to such time lag bias compensation, and FIG. 5B illustrates an example of a report that may be generated based on the customer data after the time lag bias compensation has been applied to the customer data. As illustrated in FIG. 5A, prior to time lag bias compensation, an uncompensated year-over-year trend 100 may indicate a generally decreasing trend in the year-over-year change of customer transactions associated with identified customers of the retailer between the months of January and December of the reporting years. Uncompensated trend 100 is a curve fit to the actual customer transaction data represented by the line plot illustrated in FIG. 5A. As further illustrated in FIG. 5A, uncompensated trend 100 is generally opposite that of actual trend 102. That is, in the example of FIG. 5A, actual trend 102 may represent the true year-over-year change in customer transactions associated with identified customers of the retailer if enough time were allowed after the reporting period to identify all of the identifiable customers. As illustrated in FIG. 5A, actual trend 102 indicates a generally increasing trend the year-over-year change of such customer transactions. Thus, uncompensated trend 100 and actual trend 102 of FIG. 5A illustrates the bias in customer transaction data of the retailer caused by the time lag in identifying customers associated with the transactions.

In the example of FIG. 5B, compensated trend 104 illustrates a trend in the year-over-year change of customer transactions associated with identified customers based on the customer data after the time lag bias compensation is applied to the customer data. As illustrated, compensated trend 104 may more closely match actual trend 102.

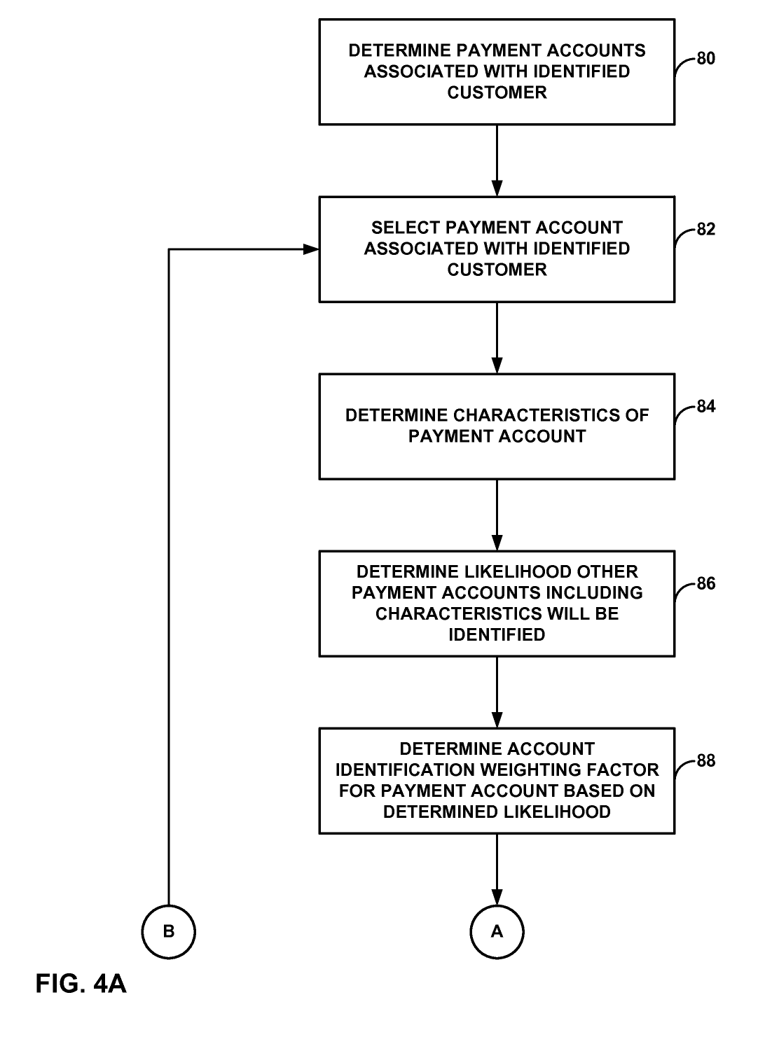

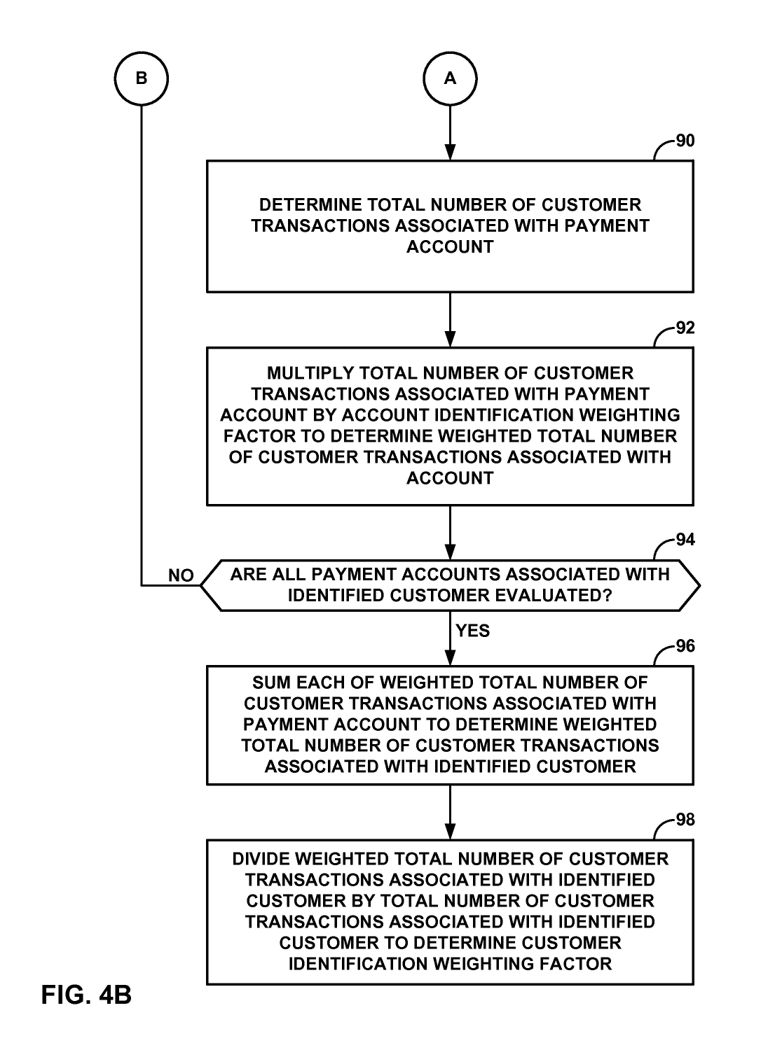

Customer identification weighting factor module 54 may select an identified customer of the plurality of identified customers (64). Customer identification weighting factor module 54 may also determine a customer identification weighting factor for the identified customer based on a customer identification likelihood (66). For example, as described in further detail below with respect to FIGS. 4A-4B, customer identification weighting factor module 54 may determine one or more payment accounts associated with the identified customer (e.g., one or more of a credit card account number, a debit card account number, etc.), and may determine the customer identification likelihood weighting factor based on one or more characteristics of one or more payment accounts associated with the identified customer.

Customer identification weighting factor module 54 may also multiply a total number of customer transactions of the second plurality of customer transactions associated with the identified customer by the customer identification weighting factor to determine a weighted total number of customer transactions for the identified customer (68). For instance, customer identification weighting factor module 54 may determine, based on a customer identification likelihood of the identified customer, a customer identification weighting factor for the identified customer as the number two. The customer identification weighting factor may, in certain examples, be viewed as a coefficient to compensate for customer transactions associated with unidentified customers that may be unidentified due to the customer identification process. For instance, customer identification weighting factor module 54 may determine that a particular customer is fifty percent likely to be identified by the customer identification process. In this example, customer identification weighting factor module 54 may determine a customer identification weighting factor for the identified customer as the number two, thereby representing the particular identified customer as two customers with similar characteristics to the identified customer (e.g., a type of a payment account associated with the identified customer, an age of the payment account associated with the identified customer, and a region of the payment account tender type associated with the identified customer). As such, customer identification weighting factor module 54 may effectively increase the representation of customer transactions in the second plurality of customer transactions associated with the identified customer based on the identification likelihood of the identified customer.

For instance, in this example, the second plurality of customer transactions associated with the identified customer (i.e., the plurality of customer transactions included in the second set of customer data from which one or more customer transactions have been removed) may indicate that the identified customer is associated with thirty total transactions. Customer identification weighting factor module 54 may multiply the thirty total transactions (i.e., the total number of customer transactions of the second plurality of customer transactions associated with the identified customer in this example) by the number two (i.e., the customer identification weighting factor in this example) to determine a weighted total number of sixty customer transactions for the identified customer.

Customer identification weighting factor module 54 may associate the weighted total number of customer transactions for the identified customer with the identified customer in the second set of customer data (70). Customer identification weighting factor module 54 may determine whether each identified customer of the plurality of identified customers has been evaluated, such that a weighted total number of customer transactions for each of the identified customers in the plurality of identified customers has been determined and associated with the identified customer in the second set of customer data (72). When customer identification weighting factor module 54 determines that at least one of the plurality of identified customers has not been evaluated (“NO” branch of 72), customer identification weighting factor module 54 may select a next identified customer of the plurality of identified customers. In such a way, customer identification weighting factor module 54 may perform operations 66, 68, and 70 for each identified customer of the plurality of identified customers. In some examples, customer identification weighting factor module 54 may not explicitly select an identified customer of the plurality of identified customers, but may otherwise iteratively perform operations 66, 68, and 70 for each identified customer of the plurality of customers.

When customer identification weighting factor module 54 determines that each of the plurality of identified customers has been evaluated (“YES” branch of 72), reporting module 56 may output a report including a representation of the second set of customer data (74). For example, the report may include an indication of a percentage change of a total number of weighted total numbers of customer transactions that occurred during the first time period (e.g., a reporting time period of the year 2011) and which are associated with an identified customer versus a total number of weighted total numbers of customer transactions that occurred during the second time period (e.g., a reporting time period of the year 2010) and which are associated with an identified customer.

By further compensating for biases introduced into the customer transaction data by the customer identification process (e.g., biases based on a likelihood of identifying a customer associated with one or more transactions), computing device 30 may enable an even more accurate comparison of customer transactions associated with identified customers of the retailer as between a first time period and a second time period. As an example, FIG. 5C illustrates an example report that may be generated based on customer data after such compensations have been applied. As illustrated in FIG. 5C, compensated year-over-year trend 106 may indicate a generally increasing trend in the year-over-year change of customer transactions associated with identified customers that more closely matches actual trend 102 than either of trend 104 of FIG. 5B or trend 102 of FIG. 5A.

FIGS. 4A and 4B are flow diagrams illustrating the example operations of FIG. 3 to determine a customer identification weighting factor in further detail. In particular, FIGS. 4A and 4B illustrate an example of operation 66 of FIG. 3 in further detail. The example illustrated in FIGS. 4A and 4B is only one example operation, and other implementations may include more or fewer aspects than those depicted in FIGS. 4A and 4B. For purposes of illustrations only, the example operations are described below as carried out by computing device 30.

Payment account identification module 50 may determine one or more payment accounts associated with the identified customer (80). For instance, the identified customer may be associated with one or more payment accounts in the second set of customer data, such as one or more credit card accounts, one or more debit card accounts, one or more gift card accounts, and the like. Payment account identification module 50 may determine the one or more payment accounts associated with the identified customer in the second set of customer data.

Account identification weighting factor module 52 may select a payment account of the one or more payment accounts associated with the identified customer (82). Account identification weighting factor module 52 may also determine one or more characteristics of the payment account (84). For example, the one or more characteristics of the payment account may include one or more of a type of the payment account, an age of the payment account, and a region of the payment account. The type of the payment account may include one of a credit card account associated with the retailer, a debit card account associated with the retailer, a gift card associated with the retailer, a debit card associated with a third-party financial institution, and a credit card associated with a third-party financial institution.

The age of the payment account may be determined based on a first time the payment account was used for a customer transaction at the retailer. For instance, the age of the account may be determined as a time difference between a time when the payment account was first used for a customer transaction at the retailer and a time when the first set of customer data is retrieved.

The region of the retail account may be determined based on a geographical location of one or more retail stores of the retailer. For instance, the retailer may include a plurality of retail stores located at a plurality of geographical locations. In some examples, the region of the retail account may be determined based on a geographical location of one or more of the plurality of retail stores at which the largest number of customer transactions associated with the payment account occurred. For instance, the payment account may be associated with thirty transactions, twenty of which occurred at one or more retail stores in the state of Minnesota and ten of which occurred at one or more retail stores in the state of Wisconsin. As such, in some examples, the region of the payment account may be determined as the state of Minnesota (i.e., the state at which the largest number of transactions occurred). In certain examples, the region of the payment account may be determined as an area that is larger than a state, such as the Midwest region in this example. In some examples, the region of the payment account may be determined as an area that is smaller than a state, such as a county, city, or neighborhood within a city.

Account identification weighting factor module 52 may determine a likelihood that other payment accounts comprising the one or more characteristics will be identified (86). For instance, account identification weighting factor module 52 may retrieve a third set of customer data comprising a plurality of customer transactions associated with other payment accounts comprising the characteristics. Account identification weighting factor module 52 may determine the likelihood that other payment accounts including the characteristics will be identified based on the percentage of the payment accounts of the third set of customer data that are associated with an identified customer of the retailer.

As an example, account identification weighting factor module 52 may determine that the payment account is a credit card account associated with a third-party financial institution (e.g., a type of the account) that has been used at the retailer for one year (e.g., the age of the account) in Louisiana (e.g., the region of the account). Account identification weighting factor module 52 may retrieve a third set of customer data including a plurality of customer transactions associated with other third-party financial institution credit card accounts that have been used at the retailer for one year in Louisiana. Account identification weighting factor module 52 may determine a percentage of the payment accounts of the third set of customer data that are associated with an identified customer of the retailer. For instance, account identification weighting factor module 52 may determine that eighty-four percent of the payment accounts of the third set of customer data are associated with identified customers of the retailer. In such an example, account identification weighting factor module 52 may determine the likelihood that other payment accounts including the characteristics (e.g., credit card accounts associated with third-party financial institutions that have been used at the retailer for one year in Louisiana) will be identified as eighty-four percent.

Account identification weighting factor module 52 may determine the account identification weighting factor based on the determined likelihood that other payment accounts comprising the characteristics will be identified (88). For example, account identification weighting factor module 52 may determine the account identification weighting factor as a reciprocal of the determined percentage of payment accounts including the characteristics that have been successfully identified. As an example, account identification weighting factor module 52 may determine the likelihood that other payment accounts including the characteristics will be identified as fifty percent. In such an example, account identification weighting factor module 52 may determine the account identification weighting factor as the number two (i.e., the reciprocal of the determined likelihood).

Account identification weighting factor module 52 may determine a total number of customer transactions of the second plurality of customer transactions associated with the payment account (90). For example, account identification weighting factor module 52 may determine that the payment account (e.g., a credit card account associated with a third-party financial institution) is associated with thirty transactions in the second set of customer data (i.e., the set of customer data from which one or more customer transactions associated with identified customers that are associated with an identified customer that was identified after the second time period, such as the year 2010, have been removed).

Account identification weighting factor module 52 may multiply the total number of customer transactions of the second plurality of customer transactions associated with the payment account by the account identification weighting factor to determine a weighted total number of customer transactions of the second plurality of customer transactions associated with the payment account (92). For instance, account identification weighting factor module 52 may determine a total number of thirty customer transactions associated with the payment account and an account identification weighting factor associated with the payment account as the number two. In such an example, account identification weighting factor module 52 may multiply the thirty total customer transactions associated with the payment account by the account identification weighting factor of the number two to determine a weighted total number of sixty customer transactions associated with the payment account.

Account identification weighting factor module 52 may determine whether each of the payment accounts associated with the identified customer has been evaluated so as to determine a weighted total number of customer transactions associated with each payment account associated with the identified customer (94). When account identification weighting factor module 52 determines that at least one payment account associated with the identified customer has not been evaluated (“NO” branch of 94), account identification weighting factor module 52 may select a next payment account associated with the identified customer. In such a way, account identification weighting factor module 52 may determine the weighted total number of customer transactions associated with the identified customer for each of the one or more payment accounts associated with the identified customer. In some examples, account identification weighting factor module 52 may not explicitly select a payment account associated with the identified customer, but may otherwise iteratively determine the weighted total number of customer transactions associated with the identified customer for each of the one or more payment accounts associated with the identified customer.

When account identification weighting factor module 52 determines that each of the payment accounts associated with the identified customer has been evaluated (“YES” branch of 94), customer identification weighting factor module 54 may sum each of the weighted total number of customer transactions of the second plurality of customer transactions associated with each payment account associated with the identified customer to determine a weighted total number of customer transactions of the second plurality of customer transactions associated with the identified customer (96).

As one example, three separate payment accounts may be associated with an identified customer, such as a credit card account associated with a third-party financial institution, a credit card account associated with the retailer, and a debit card account associated with a third-party financial institution. In addition, each of the three separate payment accounts may be associated with a weighted total number of customer transactions. For instance, the credit card account associated with the retailer may be associated with a weighted total number of twenty transactions, the credit card account associated with the third-party financial institution may be associated with a weighted total number of ten transactions, and the debit card account associated with a third-party financial institution may be associated with a weighted total number of five transactions. In such an example, customer identification weighting factor module 54 may sum each of the weighted total number of customer transactions associated with the payment accounts to determine a weighted total number of thirty-five transactions associated with the identified customer.

Customer identification weighting factor module 54 may determine the customer identification weighting factor as the weighted total number of customer transactions of the second plurality of customer transactions associated with the identified customer divided by the total number of customer transactions of the second plurality of customer transactions associated with the identified customer (98). For example, customer identification weighting factor module 54 may determine a total number of thirty customer transactions associated with the identified customer and a weighted total number of sixty customer transactions associated with the identified customer. In such an example, customer identification weighting factor module 54 may divide the sixty weighted total number of customer transactions associated with the identified customer by the thirty total number of customer transactions associated with the identified customer to determine a customer identification weighting factor as the number two.

As such, techniques described herein may enable a retailer to adjust customer transaction data associated with identified customers of the retailer to compensate for the time lag introduced into the customer transaction data by the customer identification process, thereby enabling more accurate comparisons of the identified customer transactions between reporting periods. In addition, techniques described herein may enable the retailer to further adjust the customer transaction data associated with identified customers of the retailer to compensate for biases introduced by a likelihood of successfully identifying a payment account associated with a customer transaction sometime in the future, thereby reducing the overrepresentation or underrepresentation of customer transactions included in the customer data.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

1. A method comprising:
retrieving, with a computing device, a first set of customer data comprising a first plurality of customer transactions of a retailer for a first time period and a second time period prior to the first time period, wherein each customer transaction of the first plurality of customer transactions is associated with an identified customer of a plurality of identified customers, and wherein an identified customer comprises a customer that is associated with a name of the identified customer and one or more of a mailing address of the identified customer and an email address of the identified customer;
removing, with the computing device, one or more customer transactions from the first set of customer data, each of which customer transaction occurred during the second time period and is associated with an identified customer that was identified after the second time period so as to determine a second set of customer data comprising a second plurality of customer transactions of the retailer for the first time period and the second time period;
for each identified customer of the plurality of identified customers:
determining, with the computing device, a customer identification weighting factor for the identified customer based on a customer identification likelihood;
multiplying, with the computing device, a total number of customer transactions of the second plurality of customer transactions associated with the identified customer by the customer identification weighting factor to determine a weighted total number of customer transactions for the identified customer; and
associating, with the computing device, the weighted total number of customer transactions for the identified customer with the identified customer in the second set of customer data; and
outputting, with the computing device, a report comprising a representation of the second set of customer data.

2. The method of claim 1, wherein determining the customer identification weighting factor for the identified customer based on the customer identification likelihood comprises:
determining one or more payment accounts associated with the identified customer;
for each of the one or more payment accounts associated with the identified customer:
determining an account identification weighting factor based on an account identification likelihood of the payment account; and
associating the account identification weighting factor with the identified customer; and
determining the customer identification weighting factor based on each of the one or more account identification weighting factors associated with the identified customer.

3. The method of claim 2, wherein determining the account identification weighting factor based on the account identification likelihood of the payment account comprises:
determining one or more characteristics of the payment account;
determining a likelihood that other payment accounts comprising the one or more characteristics will be identified; and
determining the account identification weighting factor based on the determined likelihood that other payment accounts comprising the one or more characteristics will be identified.

4. The method of claim 3, wherein the one or more characteristics of the payment account comprise one or more of a type of the payment account, an age of the payment account, and a region of the payment account.

5. The method of claim 4, wherein the type of the payment account comprises one of a credit card account associated with the retailer, a debit card account associated with the retailer, a gift card associated with the retailer, a debit card associated with a third-party financial institution, and a credit card associated with a third-party financial institution.

6. The method of claim 4, wherein the age of the payment account is determined based on a first time the payment account was used for a customer transaction at the retailer.

7. The method of claim 4, wherein the retailer comprises a plurality of retail stores located at a plurality of geographical locations, and wherein the region of the payment account is determined based on one or more of the geographical locations of the retail stores.

8. The method of claim 3,
wherein determining the likelihood that other payment accounts comprising the one or more characteristics will be identified comprises:
retrieving a third set of customer data comprising a plurality of customer transactions associated with other payment accounts comprising the one or more characteristics; and
determining the likelihood that other payment accounts comprising the one or more characteristics will be identified based on the percentage of the payment accounts of the third set of customer data that are associated with an identified customer of the retailer,
wherein determining the account identification weighting factor based on the determined likelihood that other payment accounts comprising the one or more characteristics will be identified comprises determining the weighting factor as a reciprocal of the determined percentage of the payment accounts of the third set of customer data that are associated with an identified customer of the retailer.

9. The method of claim 2, wherein determining the customer identification weighting factor based on each of the one or more account identification weighting factors associated with the identified customer comprises:
for each of the one or more payment accounts associated with the identified customer:
determining a total number of customer transactions of the second plurality of customer transactions associated with the payment account; and
multiplying the total number of customer transactions of the second plurality of customer transactions associated with the payment account by the account identification weighting factor to determine a weighted total number of customer transactions of the second plurality of customer transactions associated with the payment account;
summing each of the weighted total number of customer transactions of the second plurality of customer transactions associated with each of the one or more payment accounts associated with the identified customer to determine a weighted total number of customer transactions of the second plurality of customer transactions associated with the identified customer; and
determining the customer identification weighting factor as the weighted total number of customer transactions of the second plurality of customer transactions associated with the identified customer divided by the total number of customer transactions of the second plurality of customer transactions associated with the identified customer.

10. The method of claim 1, wherein removing the one or more customer transactions from the first set of customer data so as to determine the second set of customer data comprising the second plurality of customer transactions of the retailer for the first time period and the second time period further comprises removing, with the computing device, one or more customer transactions from the first set of customer data, each of which customer transaction occurred during the first time period and is associated with an identified customer that was identified after the first time period.

11. The method of claim 1, wherein the report comprising the representation of the second set of customer data comprises a representation of a percentage of change of a total number of weighted total numbers of customer transactions that occurred during the first time period and which are associated with an identified customer versus a total number of weighted total numbers of customer transactions that occurred during the second time period and which are associated with an identified customer.

12. A computing device, comprising:
at least one computer-readable storage device, wherein the at least one computer-readable storage device is configured to store a first set of customer data comprising a first plurality of customer transactions of a retailer for a first time period and a second time period prior to the first time period, wherein each customer transaction of the first plurality of customer transactions is associated with an identified customer; and
at least one processor configured to access information stored on the at least one computer-readable storage device and to perform operations comprising:
removing one or more customer transactions from the first set of customer data stored on the at least one computer-readable storage device, each of which customer transaction occurred during the second time period and is associated with an identified customer that was identified after the second time period so as to determine a second set of customer data comprising a second plurality of customer transactions of the retailer for the first time period and the second time period;
for each identified customer of the plurality of identified customers:
determining a customer identification weighting factor for the identified customer based on a customer identification likelihood;
multiplying a total number of customer transactions of the second plurality of customer transactions associated with the identified customer by the customer identification weighting factor to determine a weighted total number of customer transactions for the identified customer; and
associating the weighted total number of customer transactions for the identified customer with the identified customer in the second set of customer data; and
outputting a report comprising a representation of the second set of customer data.

13. The computing device of claim 12,
wherein determining the customer identification weighting factor for the identified customer based on the customer identification likelihood comprises:
determining one or more payment accounts associated with the identified customer,
for each of the one or more payment accounts associated with the identified customer:
determining an account identification weighting factor based on an account identification likelihood of the payment account; and
associating the account identification weighting factor with the identified customer; and
determining the customer identification weighting factor based on each of the one or more account identification weighting factors associated with the identified customer.

14. The computing device of claim 13, wherein determining the account identification weighting factor based on the account identification likelihood of the payment account comprises:
determining one or more characteristics of the payment account;
determining a likelihood that other payment accounts comprising the one or more characteristics will be identified; and
determining the account identification weighting factor based on the determined likelihood that other payment accounts comprising the one or more characteristics will be identified.

15. The computing device of claim 14, wherein the one or more characteristics of the payment account comprise one or more of a type of the payment account, an age of the payment account, and a region of the payment account.

16. The computing device of claim 15, wherein the type of the payment account comprises one of a credit card account associated with the retailer, a debit card account associated with the retailer, a gift card associated with the retailer, a debit card associated with a third-party financial institution, and a credit card associated with a third-party financial institution.

17. The computing device of claim 15, wherein the age of the payment account is determined based on a first time the payment account was used for a customer transaction at the retailer.

18. The computing device of claim 15, wherein the retailer comprises a plurality of retail stores located at a plurality of geographical locations, and wherein the region of the payment account is determined based on one or more of the geographical locations of the retail stores.

19. The computing device of claim 14,
wherein determining the likelihood that other payment accounts comprising the one or more characteristics will be identified comprises:
retrieving a third set of customer data stored on the at least one computer-readable storage device and comprising a plurality of customer transactions associated with other payment accounts comprising the one or more characteristics; and
determining the likelihood that other payment accounts comprising the one or more characteristics will be identified based on the percentage of the payment accounts of the third set of customer data that are associated with an identified customer of the retailer,
wherein determining the account identification weighting factor based on the determined likelihood that other payment accounts comprising the characteristics will be identified comprises determining the weighting factor as a reciprocal of the determined percentage of the payment accounts of the third set of customer data that are associated with an identified customer of the retailer.

20. The computing device of claim 13, wherein determining the customer identification weighting factor based on each of the one or more account identification weighting factors associated with the identified customer comprises:
for each of the one or more payment accounts associated with the identified customer:
determining a total number of customer transactions of the second plurality of customer transactions associated with the payment account; and
multiplying the total number of customer transactions of the second plurality of customer transactions associated with the payment account by the account identification weighting factor to determine a weighted total number of customer transactions of the second plurality of customer transactions associated with the payment account;
summing each of the weighted total number of customer transactions of the second plurality of customer transactions associated with each of the one or more payment accounts associated with the identified customer to determine a weighted total number of customer transactions of the second plurality of customer transactions associated with the identified customer; and
determining the customer identification weighting factor as the weighted total number of customer transactions of the second plurality of customer transactions associated with the identified customer divided by the total number of customer transactions of the second plurality of customer transactions associated with the identified customer.

21. The computing device of claim 12, wherein removing the one or more customer transactions from the first set of customer data stored on the at least one computer-readable storage device so as to determine the second set of customer data comprising the second plurality of customer transactions of the retailer for the first time period and the second time period further comprises removing one or more customer transactions from the first set of customer data stored on the at least one computer-readable storage device, each of which customer transaction occurred during the first time period and is associated with an identified customer that was identified after the first time period.

22. The computing device of claim 12, wherein the report comprising the representation of the second set of customer data comprises a representation of a percentage of change of a total number of weighted total numbers of customer transactions that occurred during the first time period and which are associated with an identified customer versus a total number of weighted total numbers of customer transactions that occurred during the second time period and which are associated with an identified customer.

23. A computer-readable storage device encoded with instructions that, when executed, cause one or more processors of a computing device to:
remove one or more customer transactions from a first set of customer data, wherein the first set of customer data comprises a first plurality of customer transactions of a retailer for a first time period and a second time period prior to the first time period, wherein each customer transaction of the first plurality of customer transactions is associated with an identified customer of a plurality of identified customers, and wherein each of customer transaction removed from the first set of customer data occurred during the second time period and is associated with an identified customer that was identified after the second time period so as to determine a second set of customer data comprising a second plurality of customer transactions of the retailer for the first time period and the second time period;
for each identified customer of the plurality of identified customers:
determine a customer identification weighting factor for the identified customer based on a customer identification likelihood;
determine a weighted total number of customer transactions for the identified customer based on the customer identification weighting factor for the identified customer; and
associate the weighted total number of customer transactions for the identified customer with the identified customer in the second set of customer data; and
output a report comprising a representation of the second set of customer data.
